(19) United States
(12) Patent Application Publication
(10) Pub. No.: US 2024/0224220 A1
(43) Pub. Date: Jul. 4, 2024

(54) Method and Apparatus for Event Triggered Positioning of Enterprise Premises Equipment in a Wireless Network

(71) Applicant: Celona, Inc., Campbell, CA (US)

(72) Inventors: Sanjeet Pandit, Campbell, CA (US); Srinivasan Balasubramanian, San Diego, CA (US)

(21) Appl. No.: 18/397,086

(22) Filed: Dec. 27, 2023

Related U.S. Application Data
(60) Provisional application No. 63/478,328, filed on Jan. 3, 2023.

(51) Int. Cl. H04W 64/00; H04W 4/14; H04W 4/90; H04W 24/10

(52) U.S. Cl. CPC H04W 64/00; H04W 4/14; H04W 4/90; H04W 24/10

(57) ABSTRACT

Systems and methods for determining the position of EPEs (Enterprise Premises Equipment) in a wireless communication system. The disclosed method and apparatus assists emergency personal determine the position of an EPE in an enterprise network and respond to an emergency. EPE location tracking in accordance with the disclosed method is initiated without requiring public emergency calling procedures. Therefore, the method does not involve talking to the PSAP (Public Safety Answering Point) and typically does not require a real person to call. If individuals make an emergency call, such calls are be handled independently of the positioning procedure of the disclosed method.

### CLAIM OF PRIORITY TO PREVIOUSLY FILED PROVISIONAL APPLICATION—INCORPORATION BY REFERENCE

This non-provisional application claims priority to an earlier-filed provisional application No. 63/478,328 filed Jan. 3, 2023, entitled “Method and Apparatus for Event Triggered Positioning of Enterprise Premises Equipment in a Wireless Network” (ATTY DOCKET NO. CEL-099-PROV), and all its contents, are hereby incorporated by reference herein as if set forth in full.

### BACKGROUND

### Technical Field

The disclosed method and apparatus relate generally to determining the position of EPEs in a wireless communication system. In particular, the disclosed method and apparatus relates to assisting emergency personal determine the position of an EPE in an enterprise network and respond to an emergency.

### Background

EPEs (Enterprise Premises Equipment) are devices that are installed or otherwise situated within an Enterprise Network location. Specific EPEs (e.g., medical emergency EPEs such as a defibrillator) are installed in public venues and enterprises. Even though EPEs are installed at specific locations (such as in buildings whose locations may be known), the EPE will likely be used at a different location, particularly where the emergency is being addressed. Therefore, it would be advantageous to track the location of the EPE, and so that emergency personnel can know where the emergency situation is happening and can respond more quickly.

### BRIEF DESCRIPTION OF THE DRAWINGS

The disclosed method and apparatus, in accordance with one or more various embodiments, is described with reference to the following FIGURES. The drawings are provided for purposes of illustration only and merely depict examples of some embodiments of the disclosed method and apparatus. These drawings are provided to facilitate the reader's understanding of the disclosed method and apparatus. They should not be considered to limit the breadth, scope, or applicability of the claimed invention. It should be noted that for clarity and ease of illustration these drawings are not necessarily made to scale.

FIG. 1 is an illustration of a network configuration in accordance with one embodiment of the disclosed method and apparatus.

The FIGURES are not intended to be exhaustive or to limit the claimed invention to the precise form disclosed. It should be understood that the disclosed method and apparatus can be practiced with modification and alteration, and that the invention should be limited only by the claims and the equivalents thereof.

### DETAILED DESCRIPTION

EPEs (e.g., medical emergency EPEs such as a defibrillator) are installed in public venues and enterprises. When an EPE is activated, its activation implicitly indicates an emergency situation, and an emergency response can be triggered. Although the initial location of the EPE may be known, the EPE will likely be moved to the site of the emergency, which may be anywhere on-campus, indoor or outdoor. Therefore, on-campus positioning of these EPEs is required at both indoor and outdoor locations. However outdoor positioning typically utilizes different positioning services than indoor positioning. For example, outdoor positioning can utilize GPS or other satellite constellations, whereas indoor position may not be able to receive the satellite signals. Furthermore, a smooth transition between outdoor and indoor positioning is highly desirable, and may be required. It is also possible for this EPE to move during the emergency, and therefore continuous tracking after activation is useful.

This mechanism of EPE location tracking will be initiated without requiring public emergency calling procedures, which would involve talking to the PSAP (Public Safety Answering Point), and typically requires a real person to call, and different procedures. If individuals dial emergency calling, that would be handled independently of the positioning procedure described herein.

The EPE location tracking mechanism is primarily intended to inform appropriate employees within the enterprise to better and more quickly identify the location of the emergency situation, and aid the emergency personnel when they arrive on campus, although it can also be used for other purposes.

In enterprise deployments, a number of APs are installed, and it is possible to make measurements from an AP (which has a known position) to an EPE; however, this generally does not provide sufficient information to accurately determine position for at least the following reason. A given AP can be assumed to have minimal coverage overlap with other APs. Minimal coverage overlap provides better frequency planning and management, given that the adjacent and nearby APs are typically assigned independent (different) frequencies to avoid neighbor cell interference issue. This implies that the UE will likely be in the footprint of only one cell, possibly two, and rarely more. However, this small number of measurements is typically insufficient to accurately determine location, and therefore cell locations cannot be reliably used to determine location; i.e., the small number of measurements do not allow conventional location algorithms used in macro networks to be employed. Therefore, alternative techniques for positioning are required to accurately and reliably determine position, and alternative techniques for indoor positioning are particularly useful.

### (1) Device Location Server (DLS)

A Device Location Server (DLS) is provided in the Enterprise network, preferably in the Core Network, to communicate with the EPEs, and store and process position information from the EPEs, beacons, and other sources. The DLS can also determine and track position of the EPEs, communicate with emergency personnel, and provide other functions as described herein.

### (2) Subscriptions

EPE subscriptions: The EPE can be provisioned with credentials for one or more subscriptions, such as the below subscriptions:
Wi-Fi credentials,
Private LTE/NR credentials, and
Public network credentials.

### (3) EPE States

Dormant state: In the Dormant State, the EPE has turned off the network connectivity and has no service. The dormant state will be the typical state of the EPE when it is not being used.

Active Normal state: In the Active Normal state, the EPE connects to the available networks and communicates with a specific Device Location Service (DLS) in the enterprise. To ensure that the EPE is in operating condition, the EPE may periodically transition (wake) from the Dormant state to an Active Normal state based on a defined schedule to communicate its ‘availability’, as a keep-alive indication to the DLS.

Active Emergency state: In the Active Emergency state, the EPE is actively being used to address an emergency event. In this state, the EPE continues to measure and report measurement information for the EPE location to be tracked.

### (4) Knowledge of Available Networks in the Vicinity

During most times, the EPE remains in the Dormant state, and is not actively associated with the enterprise network. However, during an emergency event, the EPE transitions to the active emergency status, and must quickly (preferably immediately) communicate over any available network. Therefore, even in the dormant state, the EPE needs to be aware of the available networks for which it has valid credentials so that when the EPE transitions to the active emergency state, it can quickly find the connectivity it needs.

The EPE can determine the available networks for which it has valid credentials based on one or more of the below approaches:
a manual trigger,
a periodic timer, and
Telescopic/exponential backoff timer.

The EPE will need to establish a connection with the network to ensure the credentials to associate with the network are valid.

Given that the EPE has to perform keep-alive sessions with the DLS, the EPE can establish the known networks in the vicinity, as part of that keep-alive process.

The connectivity approach selected may depend on the power sources available to the EPE, and the expected operable time and operations required using the available power.

While in an active state, the EPE determines the available networks, and in a dormant state, remembers the network(s) for which it was able to find valid associations so that they can be used for subsequent connectivity.

### (5) EPE Entering Active Emergency State

In the event of an emergency that is recognized by the activation of the EPE for use, communication with the DLS is immediately initiated. This activation can be automated based on:
Motion sensor in the EPE, and
Manual activation button, which could include breaking of the casing holding the EPE.

The EPE can use previously known networks for connectivity to quickly establish communication with the DLS. The EPE may also learn the available networks in the different locations of the enterprise either on its own, or from an external source such as crowd-sourced data. The available networks in different locations can then be provisioned on to the EPE.

The EPE may maintain several connections, using single or multiple subscriptions, to allow for redundant connectivity to the DLS. Maintaining several connections can become particularly relevant and useful when the EPE is on the move and there are blind spots associated with a single type of connectivity in the enterprise campus. This can particularly be true with harsh RF environments and retaining redundant paths become relevant.

### (6) Active Emergency State Tracking

An EPE in an active emergency state continues to send measurement information to the DLS. The measurements reported to the DLS can be one or more of the signals identified below:
Bluetooth beacons,
Wi-Fi AP information,
LTE or NR serving and neighbor pilot information from the private network,
LTE or NR serving and neighbor pilot information from the macro network(s),
Altitude assessment based on the altimeter on the EPE,
Camera sensors reading specific markers on the building walls, and
GPS position determined by the EPE.

Reporting from the EPE can be continuously done (e.g.; at periodic intervals) in order to track and record EPE movement by the DLS during the emergency.

Also, the report itself can be sent on any available connectivity that is able to reach the DLS.

### (7) Reporting Measurements: Bluetooth Beacons

The enterprise building where the EPE is located may be provisioned with Bluetooth beacons at known locations.

The EPE reads these Bluetooth beacons, and can measure and report the Bluetooth beacons' data to the DLS. Alternative embodiments are possible: this report can include only the Bluetooth beacon signatures or may additionally include the measured signal strength information and other data as well.

The power level of the Bluetooth beacons may be adjusted based on the floor plan and the location where the beacon itself is installed.

Additionally, the EPE may also transmit a Bluetooth beacon with a specific signature.

### (8) Reporting Measurements: Wi-Fi APs

The APs may provide useful data for positioning. The EPE measures the Wi-Fi AP signatures in the vicinity and reports that information to the DLS. The measurement report can include the Wi-Fi AP identifiers (BSS ID) and the signal strength of the Wi-Fi beacons measured.

### (9) Reporting Measurements: LTE/NR Pilots

The EPE can make measurements of the pilots received, which may be pilots from the private enterprise network or a macro network. The EPE measurements of the private network and the macro network pilot(s) can be indicated to the EPE through RRCReconfiguration messages apart from providing measurement gaps to trigger the actual measurements.

The measurement gaps can be avoided if the EPE has multiple receive (Rx) antennas that can be tuned away independently.

To avoid complexity, the EPE can learn the available neighbors through SIB broadcasts from the neighboring cells. Alternatively, or in addition, the EPE may be provisioned with the set of frequencies and/or cells to measure.

Reporting during the Active Emergency state may be performed with a certain periodicity and therefore the EPE may not always be connected to the network to send measurements. Regardless, the EPE still makes the required measurements of the neighbors.

The measurements may be reported to the DLS the next time the EPE connect to the network.

The measured values are aged in the EPE and may be discarded after a certain time period suggesting that they are no longer relevant. Once discarded, measurements are not reported to the DLS.

The RSRP measurements reported are used for both trilateration and vertical positioning to determine the floor of the building.

The DLS may maintain the ‘measurement information’ archive with location association to provide a more fine-tuned positioning capability without having to run through the positioning algorithm. These archives can be utilized for later positioning, and the attenuation values can be optimized and/or adjusted based on EPE type and/or receive sensitivity.

### (10) Reporting Measurements: Camera

The EPE may include a camera, and in those embodiments the EPE can enable the camera while in Active Emergency state to view its surroundings. Using the camera, the EPE can provide a continuous camera feed of its surroundings.

The camera feed can be reported as a streaming video to the DLS. Emergency personnel can view, or otherwise use this feed to determine (or assist in determining) the current location of the EPE. Also, the EPE can be programmed to recognize locally specific signatures of preestablished images in the building that appear in the camera's view.

Option 1: These images may be processed locally in the EPE to interpret the image and report the recognized image with a signature, in the report. The recognized/interpreted images are reported to the DLS, which can perform counter-checking to make a final decision on the EPE location.

Option 2: The images are reported to the DLS, and then the DLS may perform the signature recognition and determine location.

### (11) Light Beam Function

The EPE may have a light source that can act as a beacon. The EPE can generate a light beam that points at an object or direction; e.g., the light beam may point to the ceiling if indoors to allow emergency personnel to get a helpful visual aid. The light source and light beam can be particularly useful when the emergency personnel are on the same floor with a large open area. As another example, a light source beacon may be useful in an airport or other open space.

In some environments the ambient light pollution can be high (depending upon on the enterprise environment), and in such environments the light source may generate infrared (or other special color) light that is more readily distinguished from the surroundings, and the emergency personnel can use special glasses to view the infrared or special color in the light source

### (12) Text Messaging Function

The EPE may have the capability of text messaging, and may be provisioned with a subscription that supports sending text messages, and with the specific numbers to send the text messages during an Active Emergency event. These specific numbers can include people that have CPR certification in an enterprise, requesting their presence to assist at the emergency location.

Text messaging can potentially be initiated by the DLS server, which can provide useful information such as a continuous (periodic) feed on the active location of the EPE, pointing the text recipient to the location of the emergency event.

(13) Transitioning from Active Emergency to Dormant State

There are many options to implement transitioning the EPE to a dormant state, such as:
Providing a manual switch that turns off the active emergency state, and
Detecting inactivity in the EPE for certain time period. Inactivity may be detected by, e.g., lack of motion of the EPE, if the EPE has a motion detector.

When the EPE is relocated to its mounting location in the building, it may transition to a dormant state.

### (14) EPE Location Service Display

A dashboard supporting the set of EPEs in the system and enterprise can be provided, in many different configurations. For example, the status of each EPE in the system/enterprise may be shown on the dashboard. When a specific EPE transitions to an Active Emergency state, clicking on the EPE the dashboard can display information such as:
the current location of the EPE,
the trace of the path taken by the EPE,
specific other functions executed from the EPE communicated to the DLS, and
a camera feed if available.

### (15) Enterprise Network

The term “enterprise” is used herein in its broadest sense to include any organization, such as businesses, research organizations, schools, colleges, hospitals, industry organizations, and any other organization, regardless of whether or not for profit. The term “campus” is used in its broadest sense to include any area in which the enterprise operates, such as the grounds and/or buildings operated or managed by the enterprise, college campuses, research centers, industrial complexes, any business or industrial site, and others.

An enterprise wireless communication network (EN) is a private network. Private networks are operated for use within a limited area by a limited group of authorized users, whereas public networks generally cover a larger area and are open for use by anyone that subscribes to the service by the network operator. One or more ENs can be created at a location such as a warehouse, factory, research center or other building, and are usually operated by an organization for its own use. Other types of private networks may be operated by a private network manager for use by more than one organization. Although described in the context of an enterprise wireless communication network, the principles disclosed can also apply to any private wireless network.

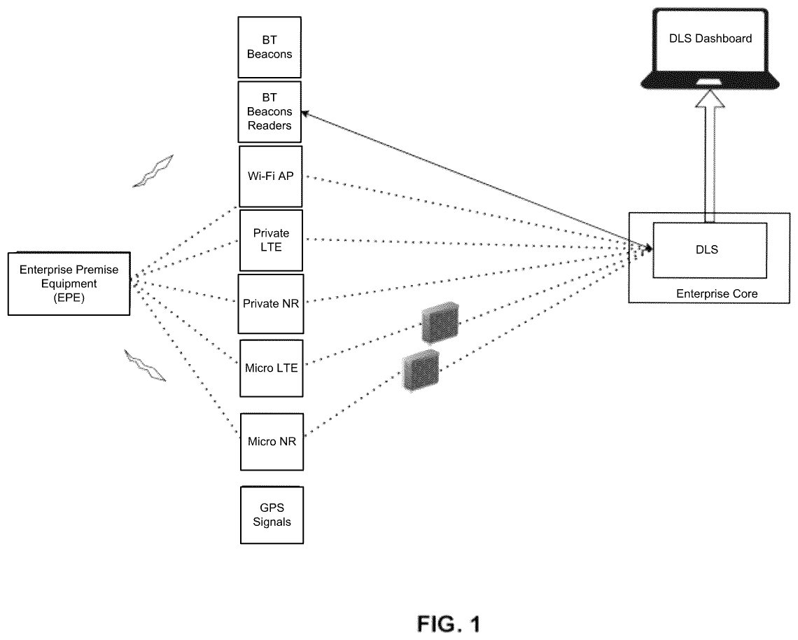

An EN may comprise any appropriate wireless network technology that can connect to UEs. For example, the LTE (4G) network shown in FIG. 1 and/or an NR (5G) Network can be implemented in an EN. In addition, the EN may also be implemented as a CBRS network using, for example, the LTE (4G) or NR (5G) technologies.

### (16) Communication Networks

Communication networks and system components may be described herein using terminology and components relating to 4G, 5G, and CBRS systems and their approved (registered) interfaces including 4G (LTE) (IEEE 802.16e), 5G NR 3GPP TS 38.300, E_UTRA (3GPP TS 36.300) communication systems. For instance, the term “CBSD” is one implementation of a Base Station/Access Point (BS/AP) and is used herein for descriptive purposes in the context of a CBRS system. The principles of the communication network described herein more widely apply to other communication networks and systems, and particularly to any spectrum-controlled communication system and network. In some embodiments, the enterprise wireless communication network operates on the CBRS band, and the BS/APs comprise CBRS devices (CBSDs) that are located at a campus location.

### (17) Acronyms

Some of the acronyms used herein are as follows:
BS/AP: Base Station/Access Point
CBRS: Citizens Broadband Radio Service
CBSD: CBRS devices
DLS: Device Location Server
EPE: Enterprise Premises Equipment
GPS: Global Positioning System. Used herein in its broadest sense to include any satellite-based positioning system
LBS: Location Based Service
PSAP: Public Safety Answering Point. PSAPs are responsible for receiving 911 calls and processing those calls according to a specific operating policy. E.g., a PSAP can be a dedicated call center for answering emergency phone calls and dispatching appropriately. When a 911 call is placed, it is important to determine call origination location; e.g., assess coordinates or use location information provisioned to the phone number.
RAN: Radio Access Network
RF: Radio Frequency
RRC: Radio Resource Control
UE: User Equipment

### (18) Enterprise Network: UEs, BS/APs, RAN, Core Network

As used herein, the term “UE”, or “devices”, or “UE devices” refers to a wide range of user devices having wireless connectivity, such as a cellular mobile phone, an Internet of Things (IOT) device, virtual reality goggles, robotic devices, autonomous driving machines, smart barcode scanners, and communications equipment including for example cell phones, desktop computers, laptop computers, tablets, and other types of personal communications devices. In some cases, the UEs may be mobile; in other cases, they may be installed or placed at a fixed position within a campus location. In other examples, the UEs may include factory sensors installed at fixed locations from which they can remotely monitor equipment such as an assembly line or a robotic arm's movement. Examples of services that can be provided to UEs by a wireless network include:
voice calls;
web browsing;
downloads of document or other information;
video (e.g., YouTube);
social media (e.g., Facebook, Twitter); and
video security cameras, sensors, and many others.

The UEs connect wirelessly over radio communication links to a Radio Access Network (RAN) that typically includes multiple base station/access points (BS/APs) that include antennas, amplifiers, and other electrical and control units for communicating with the UEs. Typically, the radio communication links operate using a Radio Resource Control (RRC) protocol, which is managed by circuitry in the BS/APs.

The term ‘BS/AP” is used broadly herein to include base stations and access points, including at least an evolved NodeB (eNB) of an LTE network or gNodeB of a 5G network, a cellular base station (BS), a Citizens Broadband Radio Service Device (CBSD) (which may be an LTE or 5G device), a Wi-Fi access node, a Local Area Network (LAN) access point, a Wide Area Network (WAN) access point, and should also be understood to include other network receiving hubs and circuitry that provide access to a network of a plurality of wireless transceivers within range of the BS/AP. Typically, the BS/APs are used as transceiver hubs, whereas the UEs are used for point-to-point communication and are not used as hubs. Therefore, the BS/APs transmit at a relatively higher power than the UEs.

A Core Network provides a number of functions and services, including an interface between the RAN and other networks. In one important function, the Core Network provides the UEs in the RAN with access to other devices and services either within its network, or on other networks such as the External PDNs. Particularly, in cellular networks and in private networks, the UEs wirelessly connect with BS/APs in the RAN, and the RAN is coupled to the Core Network. Therefore, the RAN and the Core Network provide a system that allows information to flow between a UE in the cellular or private network and other networks.

In addition to providing access to remote networks and allowing information to flow between the cellular network and the external PDNs, the Core Network may include RAN Control Units that manage the wireless network and provide control of the air interface between the BS/AP and the UEs. The Core Network may also coordinate the BS/APs to minimize interference within the network.

### (19) CBRS Networks

A Citizens Broadband Radio Service (CBRS) network utilizes the CBRS radio band of 3550-3700 MHZ, nominally divided into fifteen channels of 10 MHz each. The US Federal Government recently finalized rules (Rule 96) that allow general access to the CBRS band. The CBRS rules set forth detailed requirements for the devices that operate in a CBRS network and how they communicate. Both LTE networks and 5G networks can be implemented in CBRS systems. Base stations (BS/APs) within a CBRS network are termed “CBSDs”, and UEs are termed End User Devices (EUDs). All the CBSDs are connected to an operator Core Network by any appropriate communication means, such as wire, fiber optic, wireless radio and/or a PDN, which includes components such as an OAM Server, a SON assist unit, a Domain Proxy, an Automatic Configuration Server (ACS), a Location Database, and other databases, all of which are connected to each other within the operator Core Network by any appropriate means. The operator Core Network is connected to an SAS, which is connected to a Spectrum Database that includes data regarding the spectrum that it is managing; collectively, the SAS and the Spectrum Database are referred to as a Spectrum Management Entity (SME).

### PROGRAMMABLE EMBODIMENTS

Some or all aspects of the invention, for example aspects of the algorithmic characteristics of the invention, may be implemented in hardware or software, or a combination of both (e.g., programmable logic arrays). Unless otherwise specified, the algorithms included as part of the invention are not inherently related to any particular computer or other apparatus. In particular, various general purpose computing machines may be used with programs written in accordance with the teachings herein, or it may be more convenient to use a special purpose computer or special-purpose hardware (such as integrated circuits) to perform particular functions. Thus, embodiments of the invention may be implemented in one or more computer programs (i.e., a set of instructions or codes) executing on one or more programmed or programmable computer systems (which may be of various architectures, such as distributed, client/server, or grid) each comprising at least one processor, at least one data storage system (which may include volatile and non-volatile memory and/or storage elements), at least one input device or port, and at least one output device or port. Program instructions or code may be applied to input data to perform the functions described in this disclosure and generate output information. The output information may be applied to one or more output devices in known fashion.

Each such computer program may be implemented in any desired computer language (including machine, assembly, or high-level procedural, logical, or object-oriented programming languages) to communicate with a computer system, and may be implemented in a distributed manner in which different parts of the computation specified by the software are performed by different computers or processors. In any case, the computer language may be a compiled or interpreted language. Computer programs implementing some or all of the invention may form one or more modules of a larger program or system of programs. Some or all of the elements of the computer program can be implemented as data structures stored in a computer readable medium or other organized data conforming to a data model stored in a data repository.

Each such computer program may be stored on or downloaded to (for example, by being encoded in a propagated signal and delivered over a communication medium such as a network) a tangible, non-transitory storage media or device (e.g., solid state memory media or devices, or magnetic or optical media) for a period of time (e.g., the time between refresh periods of a dynamic memory device, such as a dynamic RAM, or semi-permanently or permanently), the storage media or device being readable by a general or special purpose programmable computer or processor for configuring and operating the computer or processor when the storage media or device is read by the computer or processor to perform the procedures described above. The inventive system may also be considered to be implemented as a non-transitory computer-readable storage medium, configured with a computer program, where the storage medium so configured causes a computer or processor to operate in a specific or predefined manner to perform the functions described in this disclosure.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide examples of instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” or “unit” does not imply that the components or functionality described or claimed as part of the module or unit are all configured in a common package. Indeed, any or all of the various components of a module or unit, whether control logic or other components, can be combined in a single package or separately maintained and can further be distributed in multiple groupings or packages or across multiple locations.

Additionally, the various embodiments set forth herein are described with the aid of block diagrams, flowcharts, and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method of determining the position of an EPE (Enterprise Premises Equipment), including establishing a DLS (Device Location Service) service for EPEs in an enterprise network.

2. The method of claim 1 wherein the EPEs (Enterprise Premises Equipment) have states including Dormant State, Active Normal State, and Active Emergency State.

3. The method of claim 1 further comprising learning and maintaining list of available networks in the vicinity of the EPE, in the EPE or the DLS.

4. The method of claim 1 wherein the EPE makes measurements including at least one of Bluetooth, Wi-Fi, LTE, NR, and Camera feeds, and reports the measurements to the DLS.

5. The method of claim 1 wherein the EPE optimizes measurements of cells in the LTE/NR private network, and macro neighbors.

6. The method of claim 1 wherein the EPE locally recognizes specific markers in the building and/or uses the DLS to perform the image recognition to determine location.

7. The method of claim 1 wherein the EPE includes a light source that generates a light beam to aid in visually spotting the EPE.

8. The method of claim 7 wherein the light source generates infrared radiation.

9. The method of claim 1 wherein the EPE sends text message(s) to notify specific individuals in the event of an emergency.
